(19) United States
(12) Patent Application Publication
(10) Pub. No.: US 2026/0220314 A1
(43) Pub. Date: Jul. 30, 2026

(54) INTRUSION DETECTION SYSTEM

(71) Applicant: Hewlett Packard Enterprise Development LP, Spring, TX (US)

(72) Inventors: Manjunath Subbanna, Bangalore (IN); Vipul Prakash Chaudhari, Bangalore (IN)

(21) Appl. No.: 19/181,440

(22) Filed: Apr. 17, 2025

(30) Foreign Application Priority Data
Jan. 24, 2025 (IN) 202511006043

(51) Int. Cl. G06F 21/86

(52) U.S. Cl. CPC G06F 21/86

(57) ABSTRACT

An example intrusion detection system and a computing system including the intrusion detection system are presented. The intrusion detection system includes a sensor, a trigger circuit, and a non-volatile memory (NVM) device. The sensor is configured to set a tamper detection signal in an active state responsive to detecting physical tampering. Further, the trigger circuit generates a status capture pulse when the tamper detection signal is in the active state. Furthermore, the NVM device receives the status capture pulse from the trigger circuit and the tamper detection signal from the sensor. The NVM device sets an intrusion detection signal to an active state at an output of the NVM device in response to receiving the status capture pulse and detecting that the tamper detection signal is in the active state, and maintains the intrusion detection signal in the active state when a power supply to the NVM device is restored.

### BACKGROUND

Computing systems may store and process personal and/or business-specific information of individuals and organizations. If not secured well, the computing systems are vulnerable to intrusions. Protecting computing systems from physical intrusions, such as someone opening or tampering with the cover, is crucial for several reasons. In particular, unauthorized physical access to the internal components of a server can lead to data breaches. Intruders can steal or corrupt sensitive data, install malicious hardware or software, or remove storage devices, leading to significant data loss and potential financial and reputational damage to the organization.

### BRIEF DESCRIPTION OF THE DRAWINGS

One or more examples in the present disclosure are described in detail with reference to the following Figures. The Figures are provided for purposes of illustration only and merely depict examples.

FIG. 1 depicts a block diagram of an example intrusion detection system.

FIG. 2 depicts an example signal sequence illustrating various signals in the example intrusion detection system of FIG. 1.

FIG. 3 depicts a schematic diagram of an example intrusion detection system.

FIG. 4 depicts a block diagram of an example computing system including an example intrusion detection system.

FIG. 5 depicts a flowchart of an example method for detecting an intrusion in a computing system.

The Figures are not exhaustive and do not limit the present disclosure to the precise form disclosed.

### DETAILED DESCRIPTION

Physical tampering with a computing system can disrupt its operational integrity. Also, physical tampering can compromise the integrity of the data stored on the server, making it difficult to ensure data accuracy and reliability. By accessing internal components of the computing system, an intruder can cause hardware damage or modify system configurations, resulting in system failures, downtime, and loss of productivity. This can be especially detrimental for organizations that rely on continuous server operation for critical business functions. Additionally, tampering with the server can void warranties and complicate maintenance and support efforts.

In traditional security setups for computing systems like servers, an intrusion detection switch connected to a cover of the computing system plays a key role in identifying unauthorized access and physical tampering. This switch is designed to detect intrusions, such as the opening of the cover, and promptly trigger alerts to system administrators. Typically, the intrusion detection switch is powered by the main supply when the server is connected to Alternating Current (AC) power. However, in the absence of AC power, such as during transit of the server or when the server is powered off, the functionality of the switch relies on a secondary power source, such as a Complementary Metal-Oxide-Semiconductor (CMOS) battery.

The secondary power source not only powers the intrusion detection switch but also maintains essential system settings, such as time and configuration data. As long as the secondary power source is operational, the intrusion detection switch can detect and record any unauthorized physical access attempts, ensuring continuous security even when the server is disconnected from external power sources.

However, a vulnerability exists in this setup. For instance, if an intruder gains physical access to the server, the intruder can remove the secondary power source after opening the cover. Once the secondary power source is removed, the intrusion detection switch may lose its power supply, thereby losing any record or status of the intrusion. This vulnerability effectively nullifies the purpose of having an intrusion detection switch, as it renders the traditional security setups incapable of detecting or reporting any intrusion after the secondary power source is removed. Such a scenario creates a critical gap in security. In particular, intruders with sufficient knowledge of the system's functionality can exploit this weakness to mask their tracks. By removing the secondary power source, the intruder can reset the computing system and avoid detection, allowing them to tamper with the server or access sensitive data without triggering any alerts. Furthermore, in case the intruder replaces the secondary power source with a drained secondary power source after any intrusion and tampering, there will be no traces of the intrusion or removal of the secondary power source, as it might seem like the secondary power source has drained out naturally.

The inability to detect and record physical intrusion in server environments may have significant repercussions for businesses. Critical security breaches may go unnoticed when an intrusion detection system fails to record unauthorized access, particularly when the secondary power source CMOS battery is tampered with. This lack of detection undermines the integrity of the server's security protocols and can lead to severe consequences, including data breaches, intellectual property theft, and operational disruptions. Without proper detection and documentation, organizations may face increased risk of monetary loss, legal penalties, and damage to their reputation. Such security gaps highlight the need for more robust solutions to ensure continuous protection against unauthorized physical access.

In examples consistent with the teachings of this disclosure, an intrusion detection system is proposed to safeguard a computing system by identifying unauthorized access and physical tampering. In particular, the proposed intrusion detection system is capable of reporting the detected intrusions even after a power supply to the intrusion detection system has been interrupted.

The proposed intrusion detection system includes a sensor, a trigger circuit, and a non-volatile memory (NVM) device. In one example implementation, the NVM device may be a Ferroelectric Random Access Memory (FRAM). The sensor is disposed in the computing system to detect any physical tampering (e.g., a complete or a partial opening of an enclosure of the computing system). In some examples, when the intrusion detection system is deployed in the computing system, a manageability controller of the computing device may be connected to the NVM device. Accordingly, when the computing system receives a mains power supply (i.e., the computing system is plugged into a mains power supply), the NVM device may be powered via the mains power supply. In the description hereinafter, electrical power received via the mains power supply is referred to as primary power. Further, the NVM device may also be connected to a secondary power source (e.g., a removable battery) that supplies secondary power to the NVM device when the primary power is not available. Furthermore, the sensor may be powered via the secondary power via the secondary power source.

One example of a manageability controller is a baseboard management controller (BMC), which may be implemented using a separate processing resource from a main processing resource executing a host operating system on the computing system. In some examples, the manageability controller may provide so-called “lights-out” functionality for the computing system that may allow a user (e.g., an administrator, a customer, or service personnel) to perform management operations on the computing system even if the host operating system is not installed or not functional.

Upon detecting a physical tampering event, the sensor may activate a tamper detection signal, indicating that a breach has occurred. The trigger circuit is coupled to the sensor and aids the NVM device in timely recording the breach. In particular, when the trigger circuit receives the active tamper detection signal from the sensor, it generates a status capture pulse. The status capture pulse is supplied to the NVM device as a clock signal that enables the NVM device to take an action responsive to the tamper detection signal that the NVM device receives from the sensor. In particular, the NVM device is connected to the sensor and the trigger circuit. The NVM device receives both the status capture pulse from the trigger circuit and the tamper detection signal from the sensor. Upon receiving these inputs, the NVM device sets an intrusion detection signal to an active state at its output indicating that the NVM device has recorded the breach.

In some implementations, the output of the NVM device may be connected to a manageability controller of the computing system. By reading the output of the NVM device, the manageability controller may learn that the breach has occurred and take necessary action, for example, generating an alert or notifying an administrator.

One of the features of the proposed intrusion detection system is the integration of the NVM device with the trigger circuit. In particular, the trigger circuit generates the status capture pulse to enable the NVM device to read the tamper detection signal. In particular, the trigger circuit activates the status capture signal such that the rising edge of the status capture pulse occurs after the tamper detection signal is activated ensuring that the NVM device reads the tamper detection signal accurately. Furthermore, the NVM device maintains the intrusion detection signal in the active state even if the power to the NVM device is lost. For instance, when the electrical power to the NVM device is restored after an interruption, the NVM device may again set the intrusion detection signal to the active state. This capability is useful for preserving the integrity of the security system, as it ensures that any tampering event is reliably recorded and reported, even after a power interruption. In summary, the proposed intrusion detection system leverages a sensor, a trigger circuit, and a non-volatile memory device to provide robust protection against unauthorized physical access. By ensuring continuous monitoring and reliable reporting of tampering events, the system enhances the security and integrity of the computing system it protects.

The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

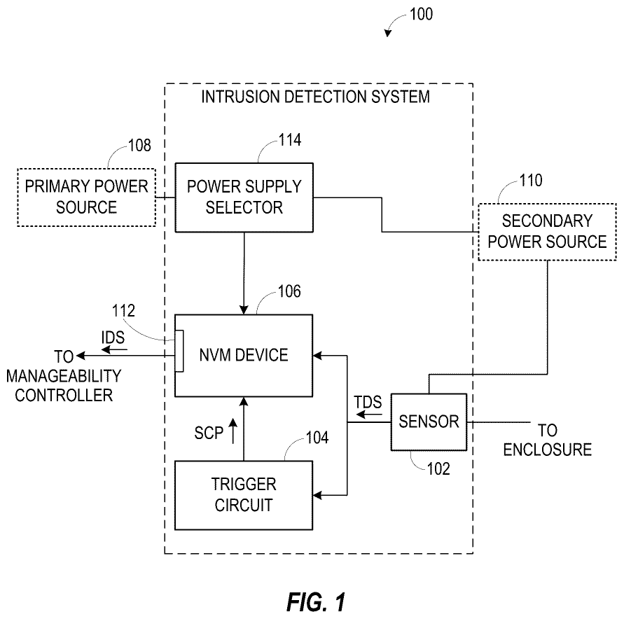

FIG. 1 depicts a block diagram of an intrusion detection system 100 in which various of the examples presented herein may be implemented. The intrusion detection system 100 may be disposed in any electronic system to detect and record physical tampering (e.g., a complete or a partial opening of an enclosure) of an electronic system. The electronic system may be a computing system such as but not limited to desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, virtual terminals, video game consoles, virtual assistants, Internet-of-Things (IoT) devices, network switches, routers, gateways, network controllers, and the like. The computing system hosting the example intrusion detection system 100 may be deployed in any setup, for example, in a home setup or an organization, such as a business, educational institution, governmental entity, healthcare facility, or other organization.

In some examples, the proposed intrusion detection system 100 includes a sensor 102, a trigger circuit 104, and a non-volatile memory (NVM) device 106. The sensor 102 may be configured to detect physical tampering with the computing system. Further, the trigger circuit 104 is coupled to the sensor 102, and the NVM device 106 is connected to both the sensor 102 and the trigger circuit 104. Furthermore, in some examples, the NVM device 106 may be connected to a power supply selector 114 to receive its operating power. In particular, the power supply selector 114 is connected to a primary power source 108 and a secondary power source 110. The primary power source 108 may be a voltage regulator configured to convert alternating-current (AC) mains power into direct-current (DC) power, referred to as primary power. The secondary power source 110 may be a removable battery, for example, a CMOS battery. An electrical power supplied from the secondary power source 110 is hereinafter referred to as a secondary power.

The power supply selector 114 is designed to selectively connect any of the primary power source 108 and the secondary power source 110 to the NVM device 106, thereby powering the NVM device 106 even in the absence of the primary power. In one example, the power supply selector 114 may be implemented via a network of electronic switches (e.g., diodes, transistors, etc.) to allow switching between the two power sources. For instance, the power supply selector 114 may include a network of two forward-biased diodes, wherein an anode of one diode is connected to the primary power source 108, an anode of the other diode is connected to the secondary power source 110, cathodes of the two diodes are connected to each other, and such a common connection point of the cathodes is connected to the NVM device 106 to supply operating power to the NVM device 106. Accordingly, when the computing device hosting the intrusion detection system 100 is plugged into the mains power supply (not shown) and when the computing device receives the mains power, the NVM device 106 may be powered via the primary power. Alternatively, when the primary power is unavailable, the NVM device 106 may be powered via the secondary power supplied by the secondary power source 110.

The sensor 102 may be powered via the secondary power supplied by the secondary power source 110. The primary power source 108 and the secondary power source 110 are shown with a dotted outline as they may not be part of the intrusion detection system 100. However, in some example implementations, the primary power source 108 and the secondary power source 110 may be part of the intrusion detection system 100.

In some examples, the sensor 102 may be an electronic switch configured to detect a physical tampering event such as a complete or a partial opening of an enclosure (e.g., a chassis cover) of the computing system in which the intrusion detection system 100 is installed. Accordingly, in one example, the sensor 102 may be an electronic switch that may be electrically coupled to the enclosure and configured to detect the physical tampering event, and set a tamper detection signal (shown as an arrow labeled as ‘TDS’) in an active state in response to detecting the physical tampering event. In another example, the sensor 102 may be an optical sensor (e.g., a photodiode or any other type of light-sensitive switch) that is activated upon the complete or partial opening of the enclosure. Once activated, the sensor may set the tamper detection signal in the active state. The tamper detection signal may be a current or a voltage signal depending on the type of the sensor.

The tamper detection signal may have two states - an active state and an inactive state, with a predefined magnitude difference therebetween. For example, if the tamper detection signal is a current signal, the tamper detection signal may have magnitudes of about 5 milliamperes (mA) and 0 mA in the active state and the inactive states, respectively. In another example, if the tamper detection signal is a voltage signal, the tamper detection signal may have magnitudes of 5 volts (V) and 0 V in the active state and the inactive state, respectively. As will be understood, the magnitudes of the tamper detection signal may be based on the magnitude of the secondary power and/or be set to values different from those noted hereinabove. As previously noted, the sensor 102 may set the tamper detection signal in the active state when the physical tampering is detected, else the sensor 102 may maintain the tamper detection signal in the inactive state.

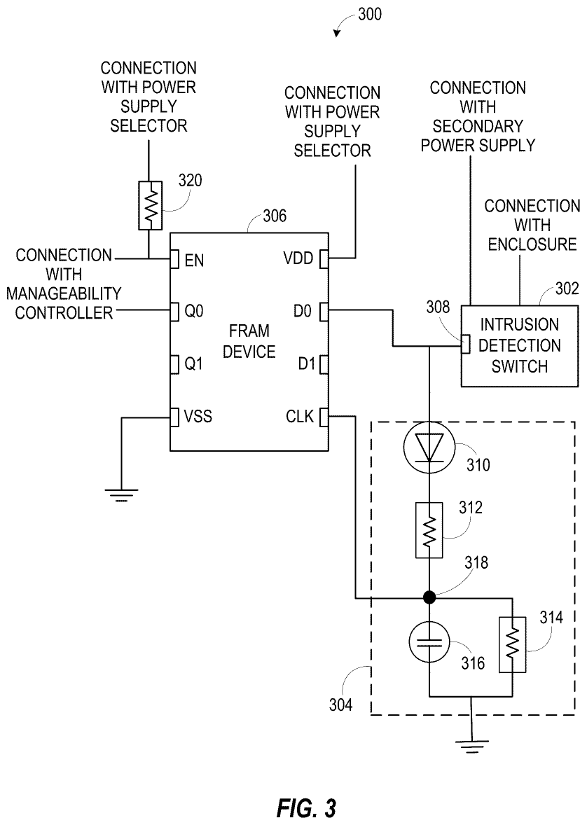

The trigger circuit 104 is coupled to the sensor 102 to receive the tamper detection signal and generate a status capture pulse (shown as an arrow labeled as ‘SCP’) when the tamper detection signal is in the active state. In a similar fashion as described in conjunction with the tamper detection signal, in some examples, the status capture pulse may be a voltage and has two states—an active state and an inactive state. In some examples, the trigger circuit 104 includes a network of elements such as one or more resistors, capacitors, inductors, etc. that can add a predefined delay to the tamper detection signal causing the generation of the status capture pulse. The status capture pulse is supplied to the NVM device as a clock signal enabling the NVM device 106 to register the tamper detection signal. Additional details about the circuit configuration of the trigger circuit 104 are described in conjunction with FIG. 3.

The NVM device 106 is connected to the sensor 102 and the trigger circuit 104. The NVM device 106 may be a storage device capable of storing data until erased or cleared, electrically. In one example, the NVM device 106 may be a low-cost memory device such as a low-bit count (e.g., two-bits) electronic storage unit that can operate with low energy. For example, the NVM device may be a Ferroelectric Random Access Memory (FRAM) device.

As previously noted, the sensor 102 activates the tamper detection signal upon detecting the physical tampering event indicating that a breach has occurred. Upon detecting that the tamper detection signal is in the active state, the trigger circuit 104 generates the status capture pulse which is supplied to the NVM device 106 as a clock signal. The NVM device 106 receives the status capture pulse from the trigger circuit 104 and the tamper detection signal from the sensor 102. Upon receiving these inputs, the NVM device 106 sets an intrusion detection signal (shown as an arrow labeled as ‘IDS’) to an active state at its output 112 indicating that the NVM device 106 has recorded the breach. In some implementations, the output 112 of the NVM device 106 may be connected to a manageability controller (not shown in FIG. 1) of the computing system. By reading the output of the NVM device 106, the manageability controller may learn that the breach has occurred and take necessary action, for example, generating an alert or notifying an administrator.

Furthermore, the NVM device 106 maintains the intrusion detection signal in the active state even if the power to the NVM device 106 is lost. For instance, even in the situation when the NVM device 106 loses both the primary power and the secondary power, and then the electrical power (e.g., any of the primary power or the secondary power) to the NVM device is restored, the NVM device 106 may again set the intrusion detection signal to the active state. This capability of NVM device 106 is useful for preserving the integrity of the intrusion detection system 100, as it ensures that any tampering event is reliably recorded and reported, even after an event where the NVM device loses power supply. By ensuring continuous monitoring and reliable reporting of tampering events, the intrusion detection system 100 enhances the security and integrity of the computing system it protects.

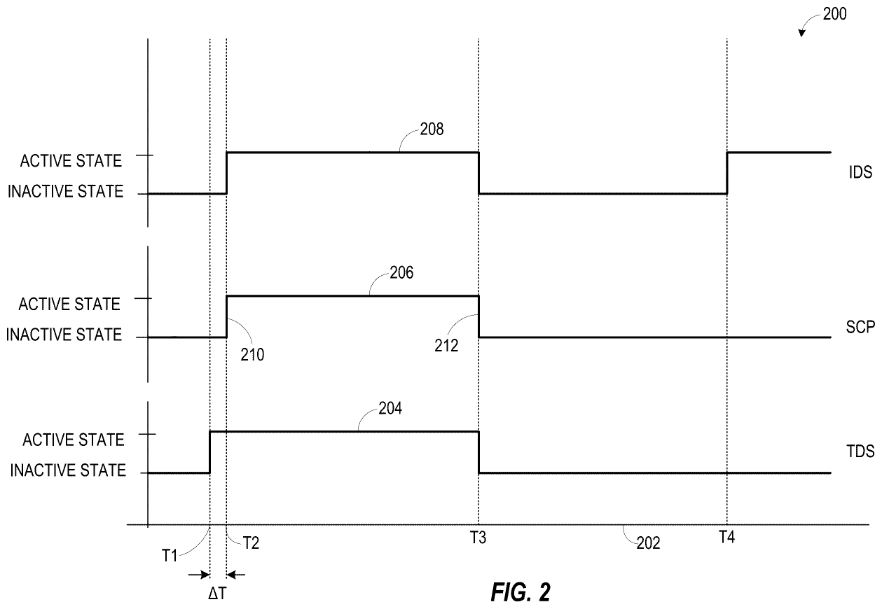

FIG. 2 depicts an example signal sequence 200 illustrating various signals shown in the example intrusion detection system 100 of FIG. 1. For ease of illustration and consistency of terminology, the signal sequence 200 of FIG. 2 is described in conjunction with the intrusion detection system 100 of FIG. 1. In the example illustration of FIG. 2, in the signal sequence 200, the tamper detection signal (TDS—marked with reference numeral 204) generated by the sensor 102, the status capture pulse (SCP—marked with reference numeral 206) generated by the trigger circuit 104, and the intrusion detection signal (IDS—marked with reference numeral 208) generated by the NVM device 106, are presented along a common timeline 202. As previously noted, each of the TDS, SCP, and IDS has a respective active state and an inactive state depending on the respective magnitudes.

On the timeline 202, time T1 marks a timestamp of a physical tampering event. Accordingly, at time T1, the sensor 102 sets tamper detection signal 204 to an active state. Further, the trigger circuit 104 sets the status capture pulse 206 to an active state after a predefined time offset (ΔT) at time T2. Further, on receiving the status capture pulse 206, the NVM device 106 sets the intrusion detection signal 208 to the active state. In particular, in one example, the NVM device 106 is configured to set, at time T2, the intrusion detection signal 208 to the active state upon detecting a rising edge 210 of the status capture pulse. As will be appreciated, the delayed generation of the status capture pulse 206 (i.e., the presence of the time offset (ΔT) between the tamper detection signal 204 and the rising edge 210 of the status capture pulse) ensures that the NVM device 106 detects the active state of the intrusion detection signal 208 before the rising edge 210 of the status capture pulse 206. In certain examples, the NVM device 106 is configured to set the intrusion detection signal 208 to the active state upon detecting a trailing edge 212 of the status capture pulse 206.

Further, time T3 marks an event when the NVM device 106 lost power (i.e., loss of both the primary power and the secondary power) which may be caused when the computing system hosting the intrusion detection system 100 loses the mains power and the secondary power source 110 is either removed or drained completely. It may be noted that the loss of power by the NVM device 106 may be a sequential or an abrupt event. In the sequential power loss, the NVM device 106 might have lost one of the two powers (e.g., the primary power or the secondary power) first followed by the loss of the other power. In the abrupt power loss event, the NVM device 106 might have lost both the primary power or the secondary power and the secondary power together.

Accordingly, all of the tamper detection signal 204, the status capture pulse 206, and the intrusion detection signal 208 may return to their respective inactive states. It may be noted that the NVM device 106 might have lost the complete power supply as a result of the intruder removing the secondary power source 110 and/or installing a drained secondary power source 110. The intruder may also have installed the enclosure back in place so that the sensor 102 cannot detect the physical intrusion.

Time T4 marks an event when the NVM device 106 regains any of the primary or the secondary power. As will be understood, the tamper detection signal 204 may remain in the inactive state as the enclosure might have been reinstalled in its position. Also, as the tamper detection signal 204 is in the inactive state, the status capture pulse 206 may also remain in the inactive state. However, when the NVM device 106 regains any of the primary or the secondary power at time T4, the NVM device 106 again sets the intrusion detection signal 208 to the active state, irrespective of the status of the tamper detection signal 204. This capability of NVM device 106 is useful for preserving the integrity of the intrusion detection system 100, as it ensures that any tampering event is reliably recorded and reported, even after an event where the NVM device 106 loses power supply.

Turning now to FIG. 3, a schematic diagram of an example intrusion detection system 300 is presented. The intrusion detection system 300 of FIG. 3 may be one example representative of the intrusion detection system 100 of FIG. 1 and includes one or more similar components, the description of which is not repeated herein for the sake of brevity. As previously described in conjunction with FIG. 1, the intrusion detection system 300 of FIG. 3 may also be disposed in any electronic system (e.g., a computing system) to detect and record physical tampering of an enclosure (e.g., a chassis enclosure). The intrusion detection system 300 includes an intrusion detection switch 302, a trigger circuit 304, and a Ferroelectric Random Access Memory (FRAM) device 306. For simplicity of illustration, a primary power source (e.g., the primary power source 108), a secondary power source (e.g., the secondary power source 110), and a power supply selector (e.g., the power supply selector 114) are not depicted in FIG. 3. Further, the intrusion detection switch 302, the trigger circuit 304, and the FRAM device 306 are example representatives of the sensor 102, the trigger circuit 104, and the NVM device 106, respectively, of FIG. 1.

The intrusion detection switch 302 may be configured to detect a physical tampering with the computing system hosting the intrusion detection system 300. Further, the trigger circuit 304 is coupled to the intrusion detection switch 302, and the FRAM device 306 is connected to both the intrusion detection switch 302 and the trigger circuit 304. Furthermore, in some examples, the FRAM device 306 may be connected to a power supply selector (not shown), such as, the power supply selector 114 described in FIG. 1 to receive an operating power. In the example implementation of FIG. 3, the FRAM device 306 may be enabled by a manageability controller, for example, via a control input such as Enable (described later). As previously noted, the power supply selector can supply electrical power to the FRAM device 306 from one or both of the primary power source (not shown) or the secondary power source (not shown).

The intrusion detection switch 302 may be an electronic switch that is electrically coupled to an enclosure of the computing system. In certain other examples, the intrusion detection switch 302 may be an optical switch. The intrusion detection switch 302 is configured to set a tamper detection signal to an active state at the switch output 308 in response to detecting physical tampering (e.g., a complete or a partial opening of the enclosure/hood) to the computing system.

The trigger circuit 304 may include a network of electronic components such as a diode 310, resistors 312 and 314, and a capacitor 316. In particular, in the example implementation depicted in FIG. 3, an anode of the diode 310 is connected to the switch output 308, and the resistor 312 is connected in series with the diode 310 at the cathode of the diode 310. Further, a parallel combination of the resistor 314 and the capacitor 316 is connected in series with the series combination of the diode 310 and the resistor 312. It may be noted that the circuit configuration of the trigger circuit 304 as depicted in FIG. 3 is for illustration purposes; other types and/or counts of electronic components may also be used and the electronic components may as well be arranged in different circuit configurations without limiting the scope of the present disclosure.

When the tamper detection signal is received by the trigger circuit 304, the network of the resistors 312, 314 and the capacitor 316 adds a predefined time offset to the tamper detection signal depending on an effective resistance-capacitance (RC) constant of the network of the resistors 312, 314 and the capacitor 316. The delayed tamper detection signal available at an output 318 of the trigger circuit 304 is referred to as a status capture pulse. In some examples, the values of the resistors 312, 314, and the capacitor 316 may be selected such that a predefined delay (e.g., 50 milliseconds) may be set between the tamper detection signal and the status capture pulse.

The FRAM device 306 may be an instant, non-volatile, highly reliable, and low-power data logging memory device that can hold data even after it is powered off. The example FRAM device 306 shown in FIG. 3 has a plurality of pins marked as Enable (EN), a first output (Q0), a second output (Q1), a first power supply pin (VSS), a clock input pin (CLK), a second power supply pin (VDD), a first input pin (D0), and a second input pin (D1). For example, an FRAM device may operate with a supply voltage of 2.7V-3.6V and may consume as low as ~0.5 μA current when idle. This voltage range and current consumption may be suitable for operating the FRAM device 306 with a secondary power source such as a CMOS battery.

The FRAM device 306 is connected to the intrusion detection switch 302 and the trigger circuit 304. In particular, the intrusion detection switch 302 and the trigger circuit 304 are connected to the FRAM device 306 at pins D0 and CLK, respectively. Accordingly, the FRAM device 306 may receive the tamper detection signal at D0 and the status capture pulse at CLK. Further, the pins EN and Q0 may be connected to external components such as a manageability controller of the computing system hosting the intrusion detection system 300. Further, the pins EN and VDD are connected to the power supply selector (not shown) to receive its operating power, and the pin VSS may be grounded, whereas the pins D1 and Q1 may not be connected to any electronic component. In one example implementation, the FRAM device 306 may be connected to the secondary power source at the EN pin via a resistor 320.

When EN is set to an active state (e.g., via a control signal from the manageability controller or via the operating power received from the power supply selector), the FRAM device 306 is activated and performs a desired function. When EN is set to inactive state, Q0 is tri-stated (i.e., remains undefined), and no operation can be performed by the FRAM device 306. In some examples, the output signal of the FRAM device 306 (referred to as an intrusion detection signal) at Q0 may be updated on a rising edge of the status capture pulse at CLK. That is when the signal at CLK transitions from low to high, an input value (i.e., the status of the tamper detection signal) available at D0 may be reflected at Q0. Similarly, as described in conjunction with FIG. 2, the FRAM device 306 can retain the previously latched value at Q0 irrespective of the values of the tamper detection signal and the status capture signals. In particular, the FRAM device 306 will hold the latched state at Q0 making it available for reading by the manageability controller on the next power ON once the EN is set to an active state. In particular, once the output is latched again at Q0, even if the secondary power source (e.g., a CMOS battery) is removed or replaced with a drained-out secondary power source, the FRAM device 306 will hold the latched state at Q0 which can be read by the manageability controller by activating EN.

Further, in some examples, once the manageability controller has read the latched state at Q0, the manageability controller may be able to reset the intrusion detection signal at Q0 by sending a status reset signal to the FRAM device 306. For example, the manageability controller may be connected to the NVM device at the CLK pin. In particular, to reset the intrusion detection signal at Q0, the manageability controller may set the status reset signal to an active state (e.g., at 3 volts or 5 volts) at the CLK pin of the FRAM device 306. Accordingly, at a rising edge of the status reset signal, the intrusion detection signal may reset based on the state of the tamper detection signal at D0. For example, when the enclosure/hood is closed, the intrusion detection signal at Q0 may reset to its inactive state. This way, the intrusion detection system can reset itself and allow the FRAM device 306 to capture any new intrusion attempts.

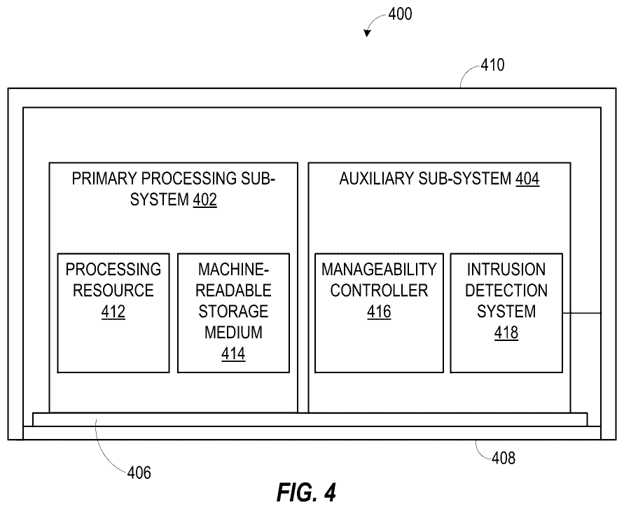

Referring to FIG. 4, a block diagram of an example computing system 400 including an example intrusion detection system is presented. The computing system 400 may be an electronic system capable of storing, processing, and/or communicating data. Examples of the computing system 400 may include desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, virtual terminals, video game consoles, virtual assistants, Internet-of-Things (IoT) devices, network switches, routers, gateways, network controllers, and the like.

In some examples, the computing system 400 may include a primary processing sub-system 402 and an auxiliary sub-system 404. The primary processing sub-system 402 may include electronic components to execute primarily intended functionalities (e.g., storing, processing, and/or communicating data), and the auxiliary sub-system 404 may include electronic components to execute auxiliary functions such as thermal management, providing remote console, etc.

Furthermore, in some examples, one or both of the primary processing sub-system 402 and the auxiliary sub-system 404 may be disposed on a baseboard 406 that may be detachably coupled to a base-body 408. The baseboard 406 may be a printed circuit board or any platform that can hold one or both the primary processing sub-system 402 and the auxiliary sub-system 404 in place. The baseboard 406 may be secured with the base-body 408 via adhesive and/or fasteners (e.g., screws, clamps, etc.). Further, the computing system 400 may include an enclosure 410 (e.g., hood) to enclose the primary processing sub-system 402 and the auxiliary sub-system 404 thereby protecting the primary processing sub-system 402 and the auxiliary sub-system 404 from external conditions. The enclosure 410 may be detachably coupled to the base-body 408. For example, the enclosure 410 may be secured with the base-body 408 via adhesives and/or fasteners (e.g., screws, clamps, etc.).

In some examples, the primary processing sub-system 402 may include a processing resource 412 and/or a machine-readable storage medium 414 for the computing system 400 to execute several operations. The processing resource 412 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 414, or combinations thereof. In one example, the processing resource 412 may fetch, decode, and execute the instructions stored in the machine-readable storage medium 414 to aid in several functionalities intended to be performed by the primary processing sub-system 402. As an alternative or in addition to executing the instructions, the processing resource 412 may include at least one integrated circuit (IC), control logic, electronic circuits, or combinations thereof that include a number of electronic components for performing the functionalities intended to be performed by the computing system 400.

The machine-readable storage medium 414 may be non-transitory and is alternatively referred to as a non-transitory machine-readable storage medium that does not encompass transitory propagating signals. The machine-readable storage medium 414 may be any electronic, magnetic, optical, or another type of storage device that may store data and/or executable instructions. Examples of the machine-readable storage medium 414 may include Randon Access Memory (RAM), Non-volatile random-access memory (NVRAM), Electrically Erasable Programmable Read-Only Memory (EEPROM), a storage drive (e.g., Solid-State Drive or Hard Disk Drive), a flash memory device, and the like. In some examples, the machine-readable storage medium 414 may store a host operating system which may be executed by the processing resource 412.

Further, in some examples, the auxiliary sub-system 404 may include a manageability controller 416 and an intrusion detection system 418. The manageability controller 416 may also be referred to as a baseboard management controller (BMC) which may be implemented using a separate processing resource from a main processing resource (e.g., the processing resource 412) executing a host operating system on the computing system 400. The manageability controller 416 may implement various accessibility services for the computing system 400. The manageability controller 416 may also provide remote management access (e.g., system console access) regardless of whether the computing system 400 is powered on (provided the computing system is plugged into the mains power supply), or whether the primary processing sub-system 402 is functioning. For example, the manageability controller 416 may enable a web-based console (e.g., user interface) using which a user can access the computing system 400 for various functionalities offered by the manageability controller 416.

In accordance with the examples presented herein, the manageability controller 416 may be connected to the intrusion detection system 418 and configured to record physical intrusion attempts reported by the intrusion detection system 418. The intrusion detection system 418 may be an example representative of the intrusion detection systems 100 or 300, details of which are not repeated herein for the sake of brevity. It may be noted that a sensor (e.g., the sensor 102 or the intrusion detection switch 302) may be configured to detect a complete or partial opening of the enclosure 410. In some examples, the sensor in the intrusion detection system 418 may be physically and/or electrically connected to the enclosure 410.

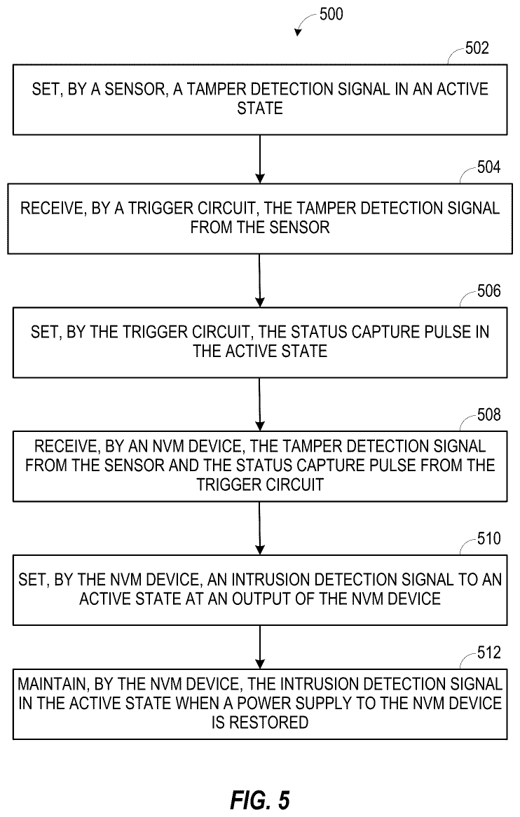

Turning to FIG. 5, a flowchart of an example method 500 for detecting a physical tampering event is presented. The steps shown in FIG. 5 may be performed by an intrusion detection system, such as the intrusion detection systems 100, 300, or 418 described hereinabove. As an alternative, the steps shown in FIG. 5 may be performed by any system implemented with suitable electronic circuits that include electronic components for performing the functionality of one or more instructions, such as an FPGA, ASIC, or other electronic circuits.

At step 502, a sensor (e.g., the sensor 102 or the intrusion detection switch 302) of an intrusion detection system (e.g., the intrusion detection systems 100, 300, or 418) may set a tamper detection signal in an active state responsive to detecting a physical tampering to the computing system. As previously noted, the sensor may be activated when the enclosure of the computing system is partially or fully opened. As a result, the tamper detection signal may be set to an active state (see FIG. 2, for example).

Further, as depicted in FIGS. 1 and 3, a trigger circuit (e.g., the trigger circuit 104 or 304) is coupled to the sensor. Accordingly, at step 504, a trigger circuit receives the tamper detection signal from the sensor.

Furthermore, at step 506, the trigger circuit may generate a status capture pulse when the tamper detection signal is in the active state. In particular, the trigger circuit sets the status capture pulse in the active state (see FIG. 2, for example) when the trigger circuit detects that the tamper detection signal is in the active state. The trigger circuit is connected to an NVM device (e.g., the NVM device 106 or the FRAM device 306) and supplies the status capture signal to the NVM device.

Moreover, at step 508, the NVM device receives the status capture pulse from the trigger circuit and the tamper detection signal from the sensor. Further, at step 510, the NVM device may set an intrusion detection signal to an active state at an output of the NVM device in response to receiving the status capture pulse and detecting that the tamper detection signal is in the active state. During the operation of the instruction detection system, there may be an event when the NVM may lose power while the tamper detection signal is in the active state. In such a situation, at step 512, the NVM device may maintain the intrusion detection signal in the active state when a power supply to the NVM device is restored. As will be appreciated, this capability of the NVM device is useful for preserving the integrity of the security system, as it ensures that any tampering event is reliably recorded and reported, even in the event of a power interruption. In summary, the proposed intrusion detection system leverages a sensor, a trigger circuit, and a non-volatile memory device to provide robust protection against unauthorized physical access. By ensuring continuous monitoring and reliable reporting of tampering events, the system enhances the security and integrity of the computing system it protects.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, third, etc., may be used herein to describe various elements, these elements should not be limited by these terms, as these terms are only used to distinguish one element from another unless stated otherwise or the context indicates otherwise.

What is claimed is:

1. An intrusion detection system comprising:
a sensor disposed in a computing system to set a tamper detection signal in an active state responsive to detecting a physical tampering to the computing system;
a trigger circuit coupled to the sensor to receive the tamper detection signal and generate a status capture pulse when the tamper detection signal is in the active state; and
a non-volatile memory (NVM) device connected to the sensor and the trigger circuit, wherein the NVM device is configured to:
receive the status capture pulse from the trigger circuit and the tamper detection signal from the sensor; and
set an intrusion detection signal to an active state at an output of the NVM device in response to receiving the status capture pulse and detecting that the tamper detection signal is in the active state, wherein the NVM device maintains the intrusion detection signal in the active state when a power supply to the NVM device is restored.

2. The intrusion detection system of claim 1, wherein the NVM device comprises a Ferroelectric Random Access Memory (FRAM).

3. The intrusion detection system of claim 1, wherein the sensor comprises a switch.

4. The intrusion detection system of claim 1, wherein the computing system comprises an enclosure detachably coupled to a base-body of the computing system, the sensor is connected with the enclosure, and wherein the physical tampering comprises complete or partial removal of the enclosure from the base-body.

5. The intrusion detection system of claim 4, wherein the NVM device is configured to set the intrusion detection signal to the active state upon detecting a rising edge of the status capture pulse.

6. The intrusion detection system of claim 5, wherein the trigger circuit is configured to generate the status capture pulse at a predefined time offset from a time the intrusion detection signal was set to the active state to ensure that the NVM device detects the active state of the intrusion detection signal before the rising edge of the status capture pulse.

7. The intrusion detection system of claim 4, wherein the NVM device is configured to set the intrusion detection signal to the active state upon detecting a trailing edge of the status capture pulse.

8. The intrusion detection system of claim 1, wherein the NVM device is coupled to a primary power source and a secondary power source of the computing system via a power supply selector, wherein the power supply selector powers the NVM device a primary power via the primary power source when the computing system is plugged into a mains power supply or using a secondary power supplied via the secondary power source when the primary power is not available, and wherein the sensor is coupled to the secondary power source and powered using the secondary power.

9. The intrusion detection system of claim 8, wherein the NVM device is coupled to a manageability controller configured to receive the intrusion detection signal from the output of the NVM device.

10. The computing system of claim 9, wherein the NVM device is configured to:
receive a status reset signal from the manageability controller; and
reset the intrusion detection signal per the tamper detection signal responsive to receiving the status reset signal.

11. A computing system, comprising:
an enclosure detachably coupled to a base-body of the computing system;
a manageability controller separate from a primary processing resource of the computing system and covered via the enclosure; and
an intrusion detection system coupled to the manageability controller and covered via the enclosure, wherein the intrusion detection system comprises:
a sensor disposed in a computing system to set a tamper detection signal in an active state responsive to detecting a complete or a partial removal of the enclosure; and
a Ferroelectric Random Access Memory (FRAM) device connected to the sensor and configured to set an intrusion detection signal to an active state at an output of the FRAM device in response to detecting that the tamper detection signal is in the active state, wherein the FRAM device maintains the intrusion detection signal in the active state when a power supply to the FRAM device is restored,
wherein the manageability controller is configured to receive the intrusion detection signal from the output of the FRAM device.

12. The computing system of claim 11, further comprising:
a primary power source to generate a primary power using a mains power supply; and
a secondary power source to generate a secondary power; and
a power supply selector coupled to the primary power source and the secondary power source,
wherein the FRAM device is coupled to the power supply selector, and wherein the power supply selector powers the FRAM device using the primary power when the mains power supply is available, and using the secondary power when the mains power supply is not available.

13. The computing system of claim 12, wherein the primary power source comprises a voltage regulator configured to supply the primary power, and the secondary power source comprises a removable battery.

14. The computing system of claim 11, wherein the intrusion detection system further comprises a trigger circuit, wherein the trigger circuit is:
coupled to the sensor to receive the tamper detection signal and generate a status capture pulse responsive to detecting that the tamper detection signal is in the active state; and
coupled to the FRAM device to supply the status capture pulse to the FRAM device.

15. The computing system of claim 14, wherein the FRAM device is configured to set the intrusion detection signal to the active state upon detecting a rising edge or a trailing edge of the status capture pulse.

16. The computing system of claim 15, wherein the trigger circuit is configured to generate the status capture pulse at a predefined time offset from a time the intrusion detection signal was set to the active state to ensure that the FRAM device detects the active state of the intrusion detection signal before the rising edge of the status capture pulse.

17. The computing system of claim 11, wherein the FRAM device is configured to:
receive a status reset signal from the manageability controller; and
reset the intrusion detection signal per the tamper detection signal responsive to receiving the status reset signal.

18. A method comprising:
setting, by a sensor, a tamper detection signal in an active state responsive to detecting a physical intrusion with a computing system;
receiving, by a trigger circuit, the tamper detection signal from the sensor;
setting, by the trigger circuit, a status capture pulse in an active state responsive to detecting the tamper detection signal is in the active state;
receiving, by a non-volatile memory (NVM) device, the tamper detection signal from the sensor and the status capture pulse from the trigger circuit;
setting, by the NVM device, an intrusion detection signal to an active state at an output of the NVM device in response to detecting that the tamper detection signal and the status capture pulse are in the active states; and
maintaining, by the NVM device, the intrusion detection signal in the active state when a power supply to the NVM device is restored.

19. The method of claim 18, wherein the physical intrusion comprises a complete or a partial opening of an enclosure of the computing system.

20. The method claim 18, wherein the NVM device is powered using a primary power supplied via a primary power source when the computing system is plugged into a mains power supply or using a secondary power supplied via a secondary power source when the primary power is not available, and wherein the sensor is coupled to the secondary power source and powered using the secondary power.
